(19) United States
(12) Patent Application Publication
(10) Pub. No.: US 2006/0004613 A1
(43) Pub. Date: Jan. 5, 2006

(54) Planner for reducing travel costs for meetings

(76) Inventors: Scott Roller, Minnetonka, MN (US); Shannon Gibson, Minnetonka, MN (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/885,522

(22) Filed: Jun. 30, 2004

(51) Int. Cl. G06F 17/60

(52) U.S. Cl. 705/6

(57) ABSTRACT

Systems and methods provide a meeting planner that provide information allowing a user to select a meeting location that provides the lowest travel related cost relative to the desired qualities for the meeting location. One aspect of the systems and methods is the use of multiple airfare types for determining the travel cost associated with the meeting. These multiple airfare types include historical average airfares, contract airfares, and zone airfares. A further aspect of the systems and methods is the calculation of hotel days required, and the use of multiple hotel rate types. These multiple hotel rate types include historical average hotel rates, contract rates and group rates.

### FIELD

The present invention relates generally to computerized systems for planning meetings, and more particularly to systems that assist in reducing travel related costs for meetings.

### COPYRIGHT NOTICE/PERMISSION

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever. The following notice applies to the software and data as described below and in the drawings hereto: Copyright© 2003, 2004, Carlson Companies, Inc. All Rights Reserved.

### BACKGROUND

It is quite common for businesses to have locations that are spread across a wide geographic area, and in fact many businesses operate from multiple locations around the world. Often, there is a need for various employees of a business to attend meetings or conferences, and due to the fact that the employees may be based at various locations, travel costs must be incurred. Travel costs for the employees to attend the meeting can be substantial, particularly when the travel distance is great or when more than a few employees must travel to the meeting.

As a result, there is a need in the art for the present invention.

### SUMMARY

The above-mentioned shortcomings, disadvantages and problems are addressed by the present invention, which will be understood by reading and studying the following specification.

The systems and methods of the present invention include a meeting planner that provides information allowing a user to select a meeting location that provides the lowest cost relative to the desired qualities for the meeting location. One aspect of the systems and methods is the use of multiple airfare types for determining the travel cost associated with the meeting. These multiple airfare types include historical average airfares, contract airfares, and zone airfares. A further aspect of the systems and methods is the calculation of hotel days required, and the use of multiple hotel rate types. These multiple hotel rate types include historical average hotel rates, contract rates and group rates.

The present invention describes systems, clients, servers, methods, and computer-readable media of varying scope. In addition to the aspects and advantages of the present invention described in this summary, further aspects and advantages of the invention will become apparent by reference to the drawings and by reading the detailed description that follows.

### BRIEF DESCRIPTION OF THE DRAWINGS

FIG. 1 is a block diagram of a meeting planner operating environment in which different embodiments of the invention can be practiced;

FIGS. 2A-2D are flowcharts illustrating methods for determining travel costs for a meeting according to an embodiment of the invention;

FIGS. 3A-3I are screen images of user interfaces according to embodiments of the invention; and

FIG. 4 is a diagram of the hardware and operating environment in conjunction with which embodiments of the invention may be practiced.

### DETAILED DESCRIPTION

In the following detailed description of exemplary embodiments of the invention, reference is made to the accompanying drawings which form a part hereof, and in which is shown by way of illustration specific exemplary embodiments in which the invention may be practiced. These embodiments are described in sufficient detail to enable those skilled in the art to practice the invention, and it is to be understood that other embodiments may be utilized and that logical, mechanical, electrical and other changes may be made without departing from the scope of the present invention.

Some portions of the detailed descriptions which follow are presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the following discussions, terms such as “processing” or “computing” or “calculating” or “determining” or “displaying” or the like, refer to the action and processes of a computer system, or similar computing device, that manipulates and transforms data represented as physical (e.g., electronic) quantities within the computer system's registers and memories into other data similarly represented as physical quantities within the computer system memories or registers or other such information storage, transmission or display devices.

In the Figures, the same reference number is used throughout to refer to an identical component which appears in multiple Figures. Signals and connections may be referred to by the same reference number or label, and the actual meaning will be clear from its use in the context of the description.

The following detailed description is, therefore, not to be taken in a limiting sense, and the scope of the present invention is defined only by the appended claims.

### OPERATING ENVIRONMENT

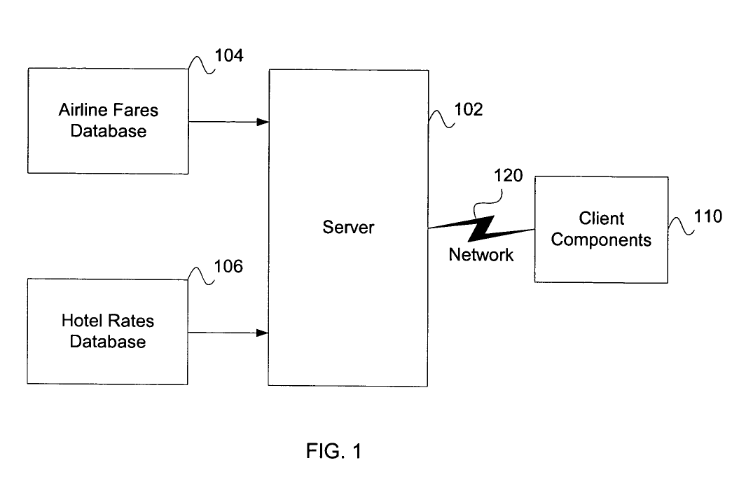

FIG. 1 is a block diagram of a meeting planner operating environment 100 in which different embodiments of the invention can be practiced. In some embodiments, planner operating environment 100 includes a server 102 coupled to an airfare database 102 and a hotel rate database 104. Client components 110 may communicate with server 102 over network 120. Network 120 may be any type of wired or wireless network, including the Internet, corporate intranets, extranets or a local area network. The embodiments of the invention are not limited to any particular type of network.

In some embodiments, airfare database 102 includes varying types of airfare information, including rates for travel between various pairs of cities (city pairs). In some embodiments, these rates may include one or more of the following:
Customer Average Rates between various city pairs. The rate for each city pair is based on a particular customer's travel. The database may include rates for more than one customer. The Customer Average Rate may include a combination of both contract rates and non-contract rates. In some embodiments, the Customer Average Rate comprises the average paid ticket history for the previous six months.
Average rates between city pairs for a travel services provider. The rate for each city pair is based on all rates for travel provided by a travel services provider. Thus the rates may be averaged across multiple customers.

In some embodiments, hotel rate database 104 includes various types of hotel rates for hotels in various cities. In some embodiments, these rates may include one or more of the following:
Customer specific contract rate—The customer specific contract rate is a hotel rate specific to a customer. In some embodiments, the customer specific contract rate excludes taxes.
Customer contract rate—The customer contract rate is a hotel rate based on the contract rates available from a Hotel Automated Rate Programme (HARP). Again, in some embodiments, the customer contract rate excludes taxes.
Estimated group rate—The Estimated group rate is a group hotel rate provided by a hotel when general information is gathered such as address, phone, etc.
Corporate rate—The corporate rate is a hotel rate that the property charges for approved corporate clients. In some embodiments, this rate may be obtained for hotels sourced from HARP.
Preferred rate—The preferred rate is a hotel rate that a travel agency has negotiated for corporate clients. In some embodiments, this rate may be obtained for hotels sourced from HARP.
Preferred Net rate—The preferred net rate is a hotel rate that a travel agency has negotiated for corporate clients less a commission. In some embodiments, this rate may be obtained for hotels sourced from HARP.
Max/Min midpoint rate—The max/min midpoint rate is a hotel rate based on the maximum rate and minimum rate associated to a hotel. The midpoint of these two rates is the max/min midpoint rate.

Either or both of airfare database 104 and hotel rate database 106 may be distributed across one or more databases and/or database management systems. In one embodiment of the invention, a portion of the hotel rate information is maintained in HARP from Carlson Wagonlit Travel.

Client program 110 provides a user interface allowing a user to provide information regarding potential meeting sites and meeting attendees. In some embodiments of the invention, client program 110 is a web browser such as Internet Explorer or Netscape Navigator.

In response to requests received from a client program 110, server program 102 executes the methods described below, utilizing data from databases 104 and 106. In some embodiments of the invention, server program 102 is a web server. In particular embodiments, the IIS (Internet Information Services) server is used. In alternative embodiments, other server software such as Netscape Server, Apache or other publicly available web server software may be used and is within the scope of the inventive subject matter.

### METHOD

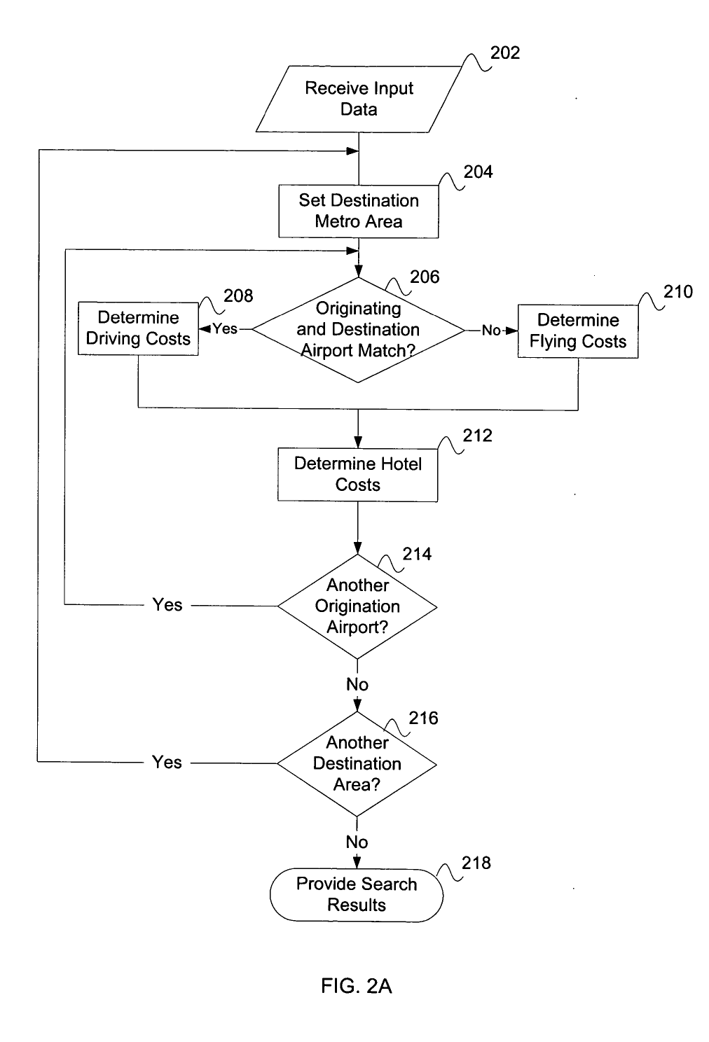

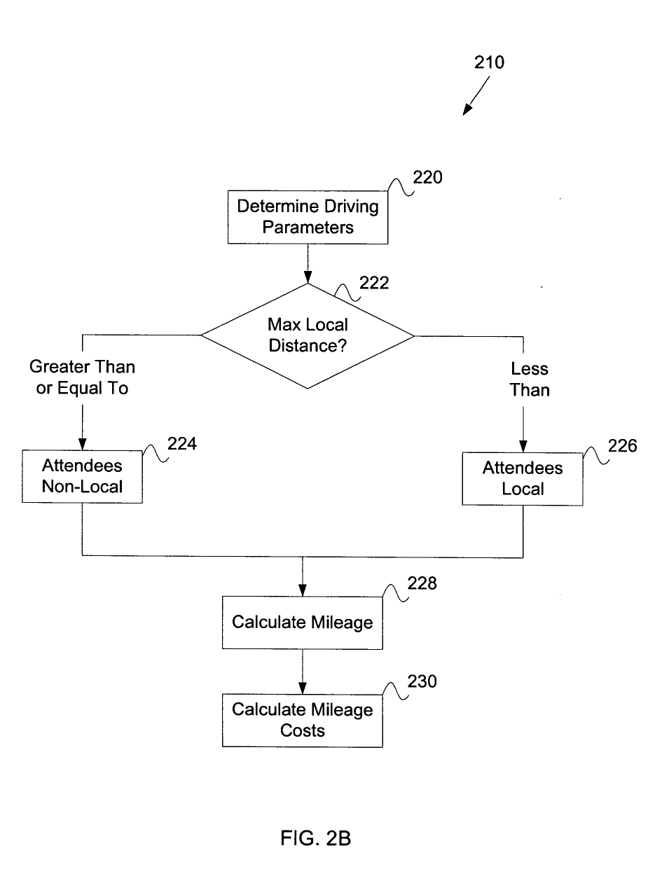

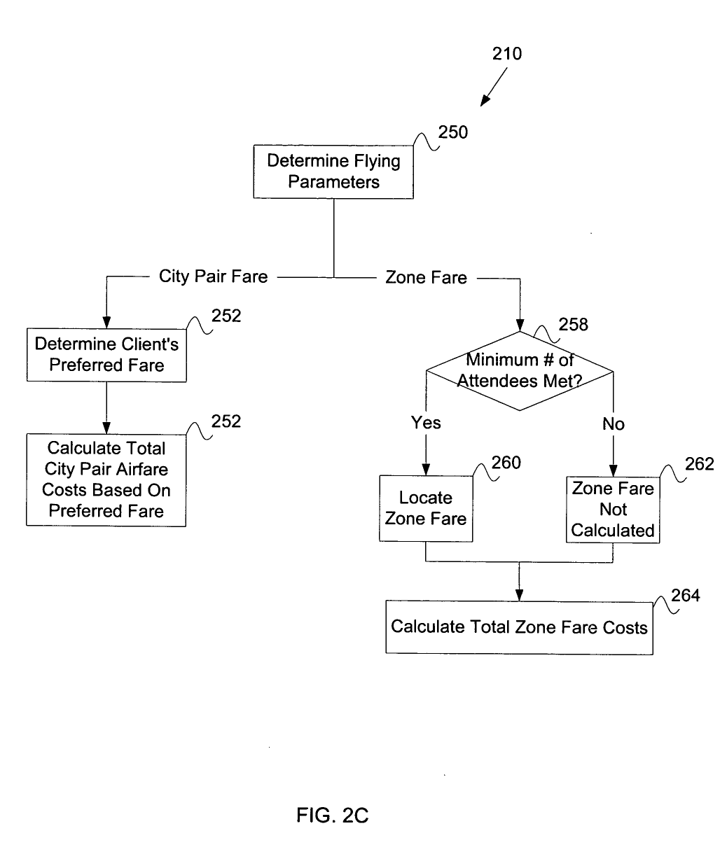

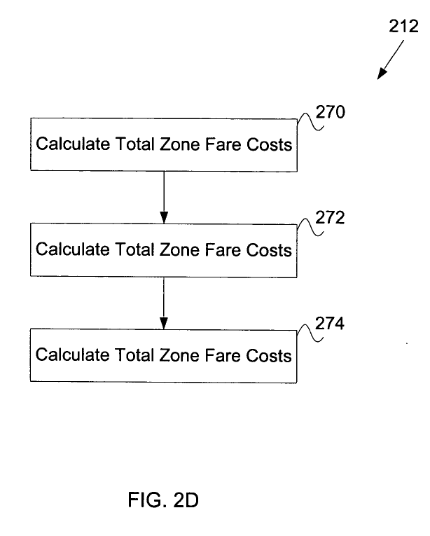

FIGS. 2A-2D are flowcharts illustrating methods for planning travel costs for a meeting according to an embodiment of the invention. The methods to be performed by the operating environment constitute computer programs made up of computer-executable instructions. Describing the methods by reference to a flowchart enables one skilled in the art to develop such programs including such instructions to carry out the methods on suitable computers (the processor or processors of the computer executing the instructions from computer-readable media). The methods illustrated in FIGS. 2A-2D are inclusive of acts that may be taken by an operating environment executing an exemplary embodiment of the invention.

FIG. 2A illustrates a method for planning travel costs according to an embodiment of the invention. The method begins by receiving input data regarding a meeting (block 202). In some embodiments, the input data include the start and end date for the meeting, one or more potential destination metropolitan areas for the meeting, and a set of one or more origination metropolitan areas and the number of attendees from each area. As those of skill in the art will appreciate, a metropolitan area may include more than one airport.

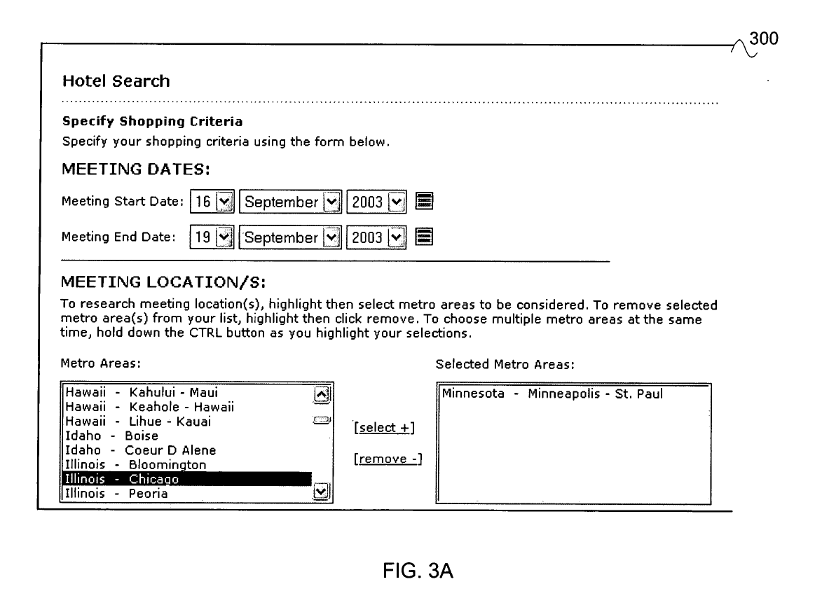

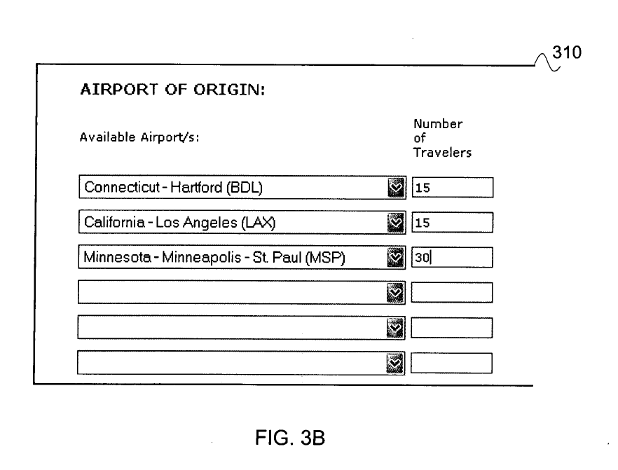

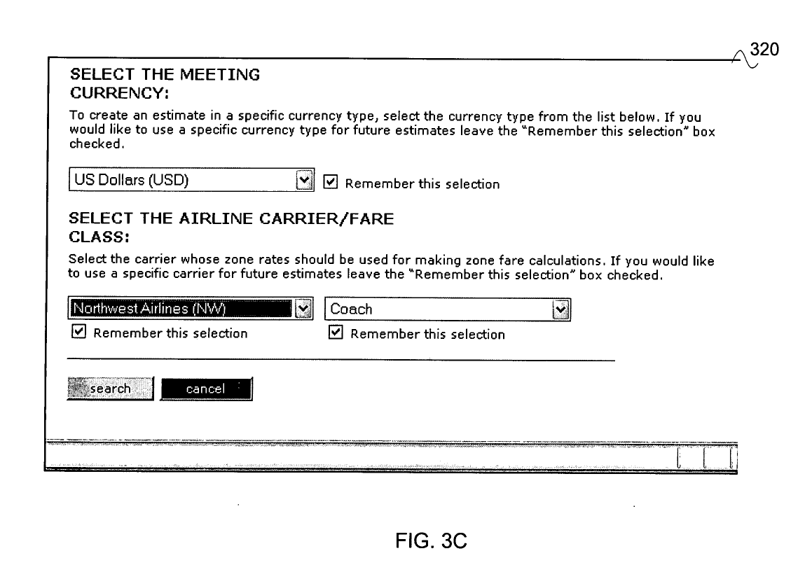

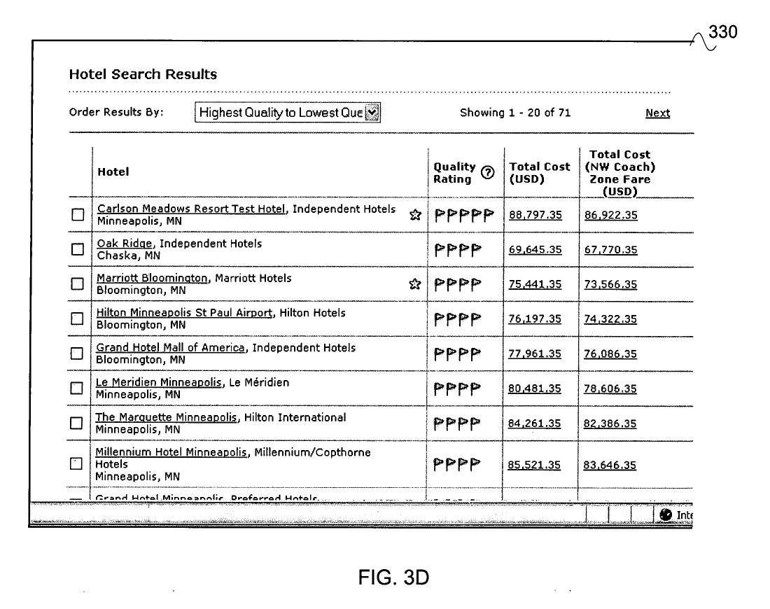

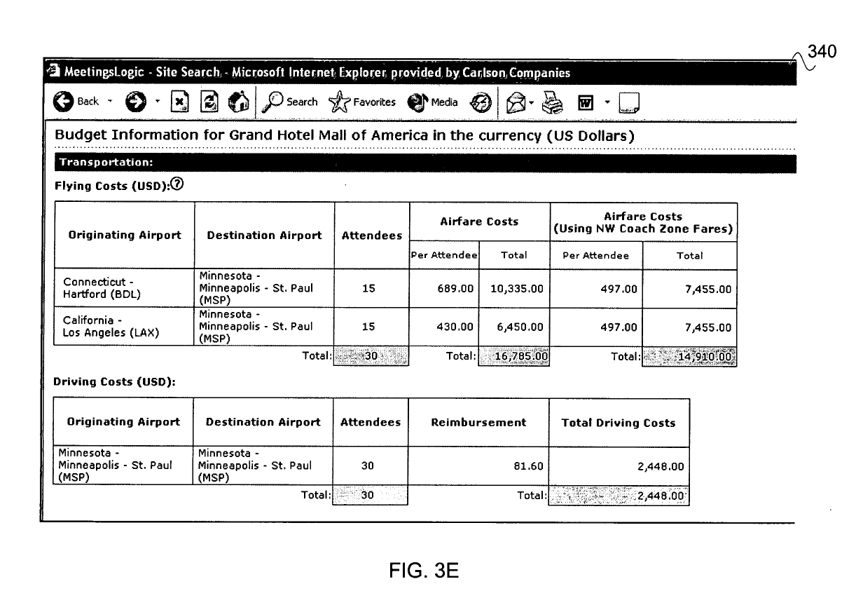

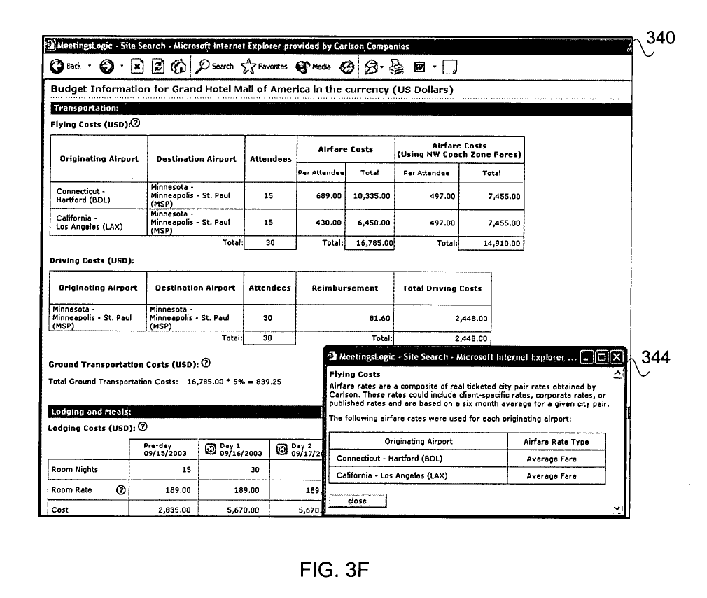

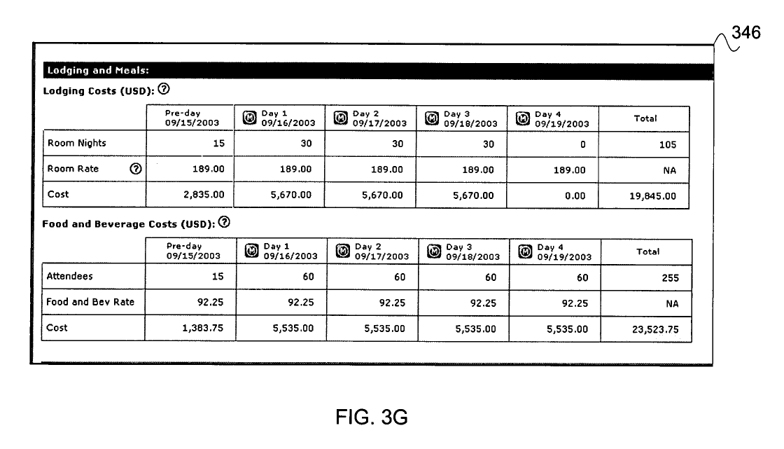

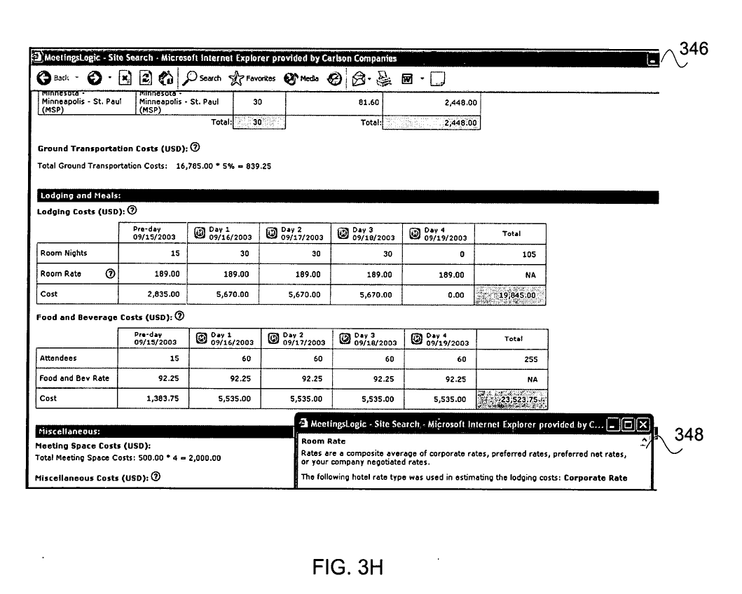

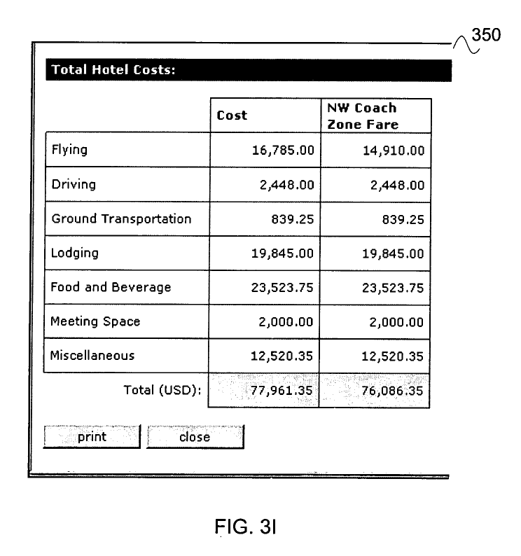

FIGS. 3A-3C are a set of screen images used in various embodiments of the invention and illustrate an exemplary user interface for providing the input data described above. An exemplary initial meeting input screen 300 is illustrated in FIG. 3A. Input screen 300 provides input means for supplying a meeting start date, a meeting end date, and a set of one or more candidate meeting locations.

FIG. 3B illustrates an exemplary second meeting input screen 310. Input screen 310 provides an interface for supplying one or more origination airports and the number of travelers using each origination airport.

FIG. 3C illustrates an exemplary third meeting input screen 320. Input screen 320 provides an interface for supplying a currency type to be used in cost calculations and a carrier to use to provide zone fare cost estimates that are to be used in estimating a meeting cost.

Returning to FIG. 2A, the system then sets up to analyze travel costs for a potential destination metropolitan area (block 204). For each origination metropolitan area, the system checks to see if the origination metropolitan area and the destination metropolitan area match (block 206). If so, the system proceeds to determine driving costs for the attendees from that origination metropolitan area (block 208). Further details on the calculation of driving costs are provided below with respect to FIG. 2B. If the origination metropolitan area and the destination metropolitan area do not match, then the system proceeds to determine flying costs for the attendees from that origination metropolitan area (block 210). Further details on the calculation of flying costs are provided below with respect to FIG. 2C.

Next, the system determines hotel costs with respect to the destination metropolitan area (block 212). In some embodiments, a set of one or more hotels in the destination metropolitan area is used to determine hotel costs. The set may be selected based on hotel quality, hotel features, customer preference, distance from airport, or other selection criteria. Further details on the calculation of hotel costs are provided below with respect to FIG. 2D.

The system then determines if another origination metropolitan remains to be analyzed (block 214). If so, the system returns to block 206 to determine the travel costs for the next origination metropolitan area with respect to the current destination metropolitan area.

Otherwise, if all origination metropolitan areas have been analyzed with respect to the current destination metropolitan area, the system proceeds to determine total travel costs for the metropolitan destination area (block 216). In some embodiments, the total travel costs are determined on a per hotel basis and include both the transportation costs (driving and/or airfare) and hotel costs.

Next, the system determines of another destination metropolitan area remains to be analyzed (block 218). If so, the system proceeds to block 204 to determine travel costs for the origination metropolitan area(s) with respect to the new destination metropolitan area.

Otherwise, the system displays the resulting meeting costs (block 220). In some embodiments, the results may be displayed on a per destination area and per hotel basis. In other words, a list of hotels in the destination metropolitan area and the total travel cost associated with the hotels is displayed. The list may be sorted based on total travel cost, by destination area, or by a user specified criteria such as hotel quality (based on ratings) or hotel features (pools, meeting rooms, room service etc.).

An exemplary user interface for displaying total travel cost results is illustrated in FIGS. 3D-3I. FIG. 3D is an illustration of an exemplary hotel search results screen 330 according to an embodiment of the invention and provides hotel search results. As illustrated, screen 330 includes a list of hotels, a quality rating for each hotel, and a total cost for meeting at the hotel (which in some embodiments includes transportation costs such as driving costs, city pair airfare costs, and zone fare costs).

FIG. 3E is an illustration of an exemplary hotel cost screen 340 according to an embodiment of the invention. Hotel cost screen 340 displays a cost breakdown for a particular hotel, including airfare (both city pair and zone fares) and driving costs associated with the selected hotel.

FIG. 3F is an illustration of an exemplary flying costs information screen 344 according to an embodiment of the invention. In some embodiments, screen 344 may partially overlay screen 340, and displays details regarding which airfare rate type was used in the cost calculations for each originating airport.

FIG. 3G is an illustration of an exemplary lodging and meal costs screen 346 according to an embodiment of the invention. Screen 346 includes a day by day cost breakdown for lodging and meals for the duration of the meeting. Screen 346 illustrates the variation in daily costs due to the fact that some attendees are within driving distance of the meeting and do not need lodging, but do require meals. Screen 346 further illustrates that some attendees must arrive a day early (e.g. the pre-day attendees) in order to arrive on time for the meeting.

FIG. 3H is an illustration of an exemplary room rate detail screen 348 according to an embodiment of the invention. Room rate detail screen may partially overlay screen 346, and provides details regarding which type of room rate was used in the costs calculations.

FIG. 3I is an illustration of an exemplary cost summary screen 350 according to an embodiment of the invention. Screen 350 provides summary costs and cost breakdowns for holding a meeting. The costs shown in some embodiments includes one or more of the following: flying costs, driving costs, ground transportation costs, lodging costs, food and beverage costs, meeting space costs, and miscellaneous costs.

A method for determining travel costs related to driving from an origination metropolitan area is illustrated in FIG. 2B. The method begins by determining driving parameters (block 220). In some embodiments, the driving parameters may include a maximum local driving distance and/or a maximum non-local driving distance. In some embodiments, the determination of whether a driver is within a maximum local driving distance will have an impact on the cost estimate for the meeting. The attendees that are considered non-local drivers will be included in the estimate for required room nights as well as effect the total cost of mileage for all drivers. Likewise, the determination of whether a driver is within the maximum non-local driving distance may be used to determine if the traveler will fly rather than drive, and thus affect the airfare and required room nights. These parameters may be customer specific, or they may be assigned default values.

Next, the system determines whether an attendee will need to drive more than the maximum local driving distance (block 222). If the attendee's driving distance will be greater than the maximum local driving distance, then the system determines that the attendee is a non-local attendee (block 224). A non-local attendee drives once to the meeting location, stays in hotel rooms for the duration of the meeting, and then drives home.

If the attendee's driving distance is less than the maximum local driving distance, the attendee is considered a local attendee (block 226). A local attendee drives to the meeting location each day of the meeting and then drives home at the end of the day. A local attendee does not need to stay at the hotel overnight.

Next, the system determines the total mileage based for each attendee based on the whether the attendee is local or non-local (block 228). The system then calculates total mileage costs for the origination metropolitan area (block 230). In some embodiments, a customer's mileage reimbursement rate is used to determine total mileage costs.

A method for determining travel costs associated with flying is illustrated in FIG. 2C. The method begins by initializing flying parameters (block 250). In some embodiments, the flying parameters includes a maximum pre-day air travel distance and/or a maximum extra night air travel distance. The maximum pre-day air travel distance represents the maximum distance that an attendee may travel and still arrive at the meeting on the meeting start day. If the air travel distance is greater than this parameter, than the air travel will commence one day prior to the start of the meeting, and an additional night will be required at the hotel. Similarly, the maximum extra night air travel distance represents the maximum distance that an attendee may travel and still arrive home on the same day that the meeting ends. If this parameter is exceeded, the attendee will commence air travel on the day following the end of the meeting, and an additional night will be required at the hotel. Either parameter may be set to customer specific values, or they may be defaulted. Those of skill in the art will appreciate that while distance (e.g. mileage) is used for certain parameters, a time value could be used as well and is within the inventive subject matter.

Next, the system calculates flying cost based on city pairs (blocks 252-256) and/or based on zone fares (blocks 258-264). City pair fares are determined as follows. First, the customer's preferred fare is determined (block 252). The customer's preferred fare may be maintained in a customer database. In some embodiments, the fare types are as described above, and include an average customer fare, a travel supplier's average fare, or a default fare. In some embodiments, the default fare comprises an average of all tickets booked by a travel agency within a time period (in some embodiments, six months). The average may be based on either domestic or international. In some embodiments, the default value may be used if a minimum number of tickets can not be found for the requested city pair. In some embodiments, the default airfare is based strictly on booked history, however in alternative embodiments, other fares, such as contracted fares may be used.

In some embodiments, in order for an average fare to be used there must be a minimum number of bookings over a minimum period. In particular embodiments, three fares must have been booked within the last six months in order for an average fare to be used. If these minimum requirements are not met, the next available fare type may be used instead.

Next, the system determines the total flying cost for the origination location based on the selected fare (block 256).

The calculation of zone fares, if they exist, begins by determining if a minimum number of attendees requirement is met for the zone fare (block 258). Certain zone fares require that a minimum number of seats be purchases. If there are enough attendees to meet the minimum requirements, the appropriate zone fare is located (block 260). In some embodiments, if there aren't enough attendees to meet the minimum requirements for a zone fare (as set for the current customer) the system may not use zone fares and rely on city pair fares alone (block 262).

Next, the system calculates the total zone fare travel costs based on the zone fares and the number of attendees that can take advantage of the zone fare (block 264).

A method for determining travel costs related to hotel stays is illustrated in FIG. 2D. The method begins by determining the travel days for the attendees at an origination metropolitan area with respect to the destination metropolitan area (block 270). The travel days calculation is based on the start and end date of the meeting, whether the attendee is a local attendee or non-local attendee as discussed above, and whether the attendee must arrive a day earlier and/or stay an extra day due to travel distances. For example, as discussed above, a local attendee drives to the hotel every day and does not need a room whereas a non-local attendee drives to the hotel, stays for the duration of the meeting, and drives home at the end of the meeting.

Next, the system determines the total number of nights required at the hotel based on the travel days (block 272). The system then determines the rate to be used for each hotel in the destination metropolitan area (block 274). The rate choices may be those stored in hotel rate database 106 described above. The total hotel cost will be determined based on the total number of nights required and the hotel rate fore each night.

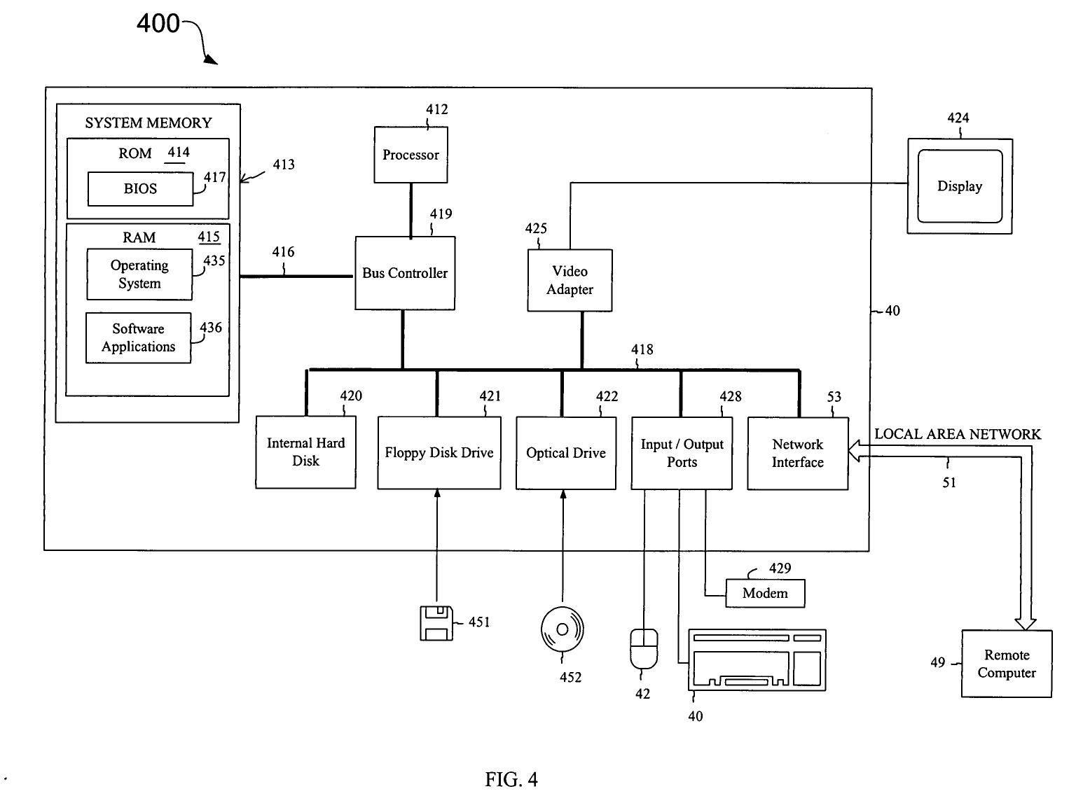

FIG. 4 is a diagram of the hardware and operating environment in conjunction with which embodiments of the invention may be practiced. The description of FIG. 4 is intended to provide a brief, general description of suitable computer hardware and a suitable computing environment in conjunction with which the invention may be implemented. Although not required, the present invention is described in the general context of computer-executable instructions, such as program modules, being executed by a computer, such as a personal computer or a server computer. Generally, program modules include routines, programs, objects, components, data structures, etc., that perform particular tasks or implement particular abstract data types.

Moreover, those skilled in the art will appreciate that the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

As shown in FIG. 4, the computing system 400 includes a processor. The invention can be implemented on computers based upon microprocessors such as the PENTIUM® family of microprocessors manufactured by the Intel Corporation, the MIPS® family of microprocessors from the Silicon Graphics Corporation, the POWERPC® family of microprocessors from both the Motorola Corporation and the IBM Corporation, the PRECISION ARCHITECTURE® family of microprocessors from the Hewlett-Packard Company, the SPARC® family of microprocessors from the Sun Microsystems Corporation, or the ALPHA® family of microprocessors from the Compaq Computer Corporation. Computing system 400 represents any personal computer, laptop, server, or even a battery-powered, pocket-sized, mobile computer known as a hand-held PC.

The computing system 400 includes system memory 413 (including read-only memory (ROM) 414 and random access memory (RAM) 415), which is connected to the processor 412 by a system data/address bus 416. ROM 414 represents any device that is primarily read-only including electrically erasable programmable read-only memory (EEPROM), flash memory, etc. RAM 415 represents any random access memory such as Synchronous Dynamic Random Access Memory.

Within the computing system 400, input/output bus 418 is connected to the data/address bus 416 via bus controller 419. In one embodiment, input/output bus 418 is implemented as a standard Peripheral Component Interconnect (PCI) bus. The bus controller 419 examines all signals from the processor 412 to route the signals to the appropriate bus. Signals between the processor 412 and the system memory 413 are merely passed through the bus controller 419. However, signals from the processor 412 intended for devices other than system memory 413 are routed onto the input/output bus 418.

Various devices are connected to the input/output bus 418 including hard disk drive 420, floppy drive 421 that is used to read floppy disk 451, and optical drive 422, such as a CD-ROM drive that is used to read an optical disk 452. The video display 424 or other kind of display device is connected to the input/output bus 418 via a video adapter 425.

A user enters commands and information into the computing system 400 by using a keyboard 40 and/or pointing device, such as a mouse 42, which are connected to bus 418 via input/output ports 428. Other types of pointing devices (not shown in FIG. 4) include track pads, track balls, joy sticks, data gloves, head trackers, and other devices suitable for positioning a cursor on the video display 424.

As shown in FIG. 4, the computing system 400 also includes a modem 429. Although illustrated in FIG. 4 as external to the computing system 400, those of ordinary skill in the art will quickly recognize that the modem 429 may also be internal to the computing system 400. The modem 429 is typically used to communicate over wide area networks (not shown), such as the global Internet. The computing system may also contain a network interface card 53, as is known in the art, for communication over a network.

Software applications 436 and data are typically stored via one of the memory storage devices, which may include the hard disk 420, floppy disk 451, CD-ROM 452 and are copied to RAM 415 for execution. In one embodiment, however, software applications 436 are stored in ROM 414 and are copied to RAM 415 for execution or are executed directly from ROM 414.

In general, the operating system 435 executes software applications 436 and carries out instructions issued by the user. For example, when the user wants to load a software application 436, the operating system 435 interprets the instruction and causes the processor 412 to load software application 436 into RAM 415 from either the hard disk 420 or the optical disk 452. Once software application 436 is loaded into the RAM 415, it can be used by the processor 412. In case of large software applications 436, processor 412 loads various portions of program modules into RAM 415 as needed.

The Basic Input/Output System (BIOS) 417 for the computing system 400 is stored in ROM 414 and is loaded into RAM 415 upon booting. Those skilled in the art will recognize that the BIOS 417 is a set of basic executable routines that have conventionally helped to transfer information between the computing resources within the computing system 400.

These low-level service routines are used by operating system 435 or other software applications 436.

In one embodiment computing system 400 includes a registry (not shown) which is a system database that holds configuration information for computing system 400. For example, Windows 95, Windows 98®, Windows® NT, Windows 2000® and Windows XP® by Microsoft maintain the registry in two hidden files, called USER.DAT and SYSTEM.DAT, located on a permanent storage device such as an internal disk.

### CONCLUSION

Systems and methods for planning travel costs associated with a meeting have been disclosed. The systems and methods described provide advantages over previous systems. For example, the system and methods may take advantage of zone fares that may be lower than city pair fares. Further, the system and methods may use fares based on a customer's historical average travel costs, and thus provide a better estimate of travel costs than previous systems.

Although specific embodiments have been illustrated and described herein, it will be appreciated by those of ordinary skill in the art that any arrangement which is calculated to achieve the same purpose may be substituted for the specific embodiments shown. This application is intended to cover any adaptations or variations of the present invention. The terminology used in this application is meant to include all of these environments.

It is to be understood that the above description is intended to be illustrative, and not restrictive. Many other embodiments will be apparent to those of skill in the art upon reviewing the above description. Therefore, it is manifestly intended that this invention be limited only by the following claims and equivalents thereof.

We claim:

1. A method for planning travel costs, the method comprising:
receiving one or more potential meeting locations;
receiving a meeting date range;
receiving one or more originating locations, each of said one or more originating locations having a number of attendees associated with the originating location.
for each of the one or more potential meeting locations determining a total location travel cost, wherein determining the total location travel cost includes determining a travel cost for each of the one or more originating locations, said travel cost including an air-travel cost based on a lower of a city-pair cost for the originating location and potential meeting location and a zone fare cost for the originating location and potential meeting location; and
displaying at least one of the total location travel costs.

2. The method of claim 1, further comprising determining hotel costs for each of the or more potential meeting locations and including said hotel costs in the total travel location costs.

3. The method of claim 1, wherein displaying at least one of the total location travel costs displays a list of hotels and a travel cost associated with each of the hotels.

4. The method of claim 3, wherein the list of hotels is sorted based on travel costs.

5. The method of claim 1, further comprising determining driving costs for the potential meeting location and including said driving costs in the total travel location costs.
